(19) United States
(12) Patent Application Publication
(10) Pub. No.: US 2012/0311183 A1
(43) Pub. Date: Dec. 6, 2012

(54) CIRCUITRY TO MAINTAIN CORRELATION BETWEEN SETS OF ADDRESSES

(76) Inventor: Patrick G. Kutch, Beaverton, OR (US)

(21) Appl. No.: 13/150,865

(22) Filed: Jun. 1, 2011

(51) Int. Cl. G06F 15/16

(52) U.S. Cl. 709/245

(57) ABSTRACT

An embodiment may include circuitry in a controller that may be included in a host that has at least one processor. The circuitry may maintain a correlation between a set of network addresses and a set of medium access control (MAC) addresses. The correlation may be generated, at least in part, by at least one process to be executed, at least in part, by the at least one processor. The circuitry may determine, based at least in part upon the set of network addresses, whether to generate at least one response to at least one request. If the circuitry determines to generate the at least one response, the circuitry may generate the at least one response based at least in part upon the correlation and at least one network address associated with the at least one request. Many alternatives, variations, and modifications are possible.

### FIELD

This disclosure relates to circuitry to maintain correlation between sets of addresses.

### BACKGROUND

In a conventional network arrangement, a server is coupled to a network. The server's host processor executes a virtual machine manager that provides a virtualized environment in which multiple virtual machines are concurrently executed in the server. In accordance with a conventional address resolution protocol (ARP), the server may receive an ARP request from the network. In this conventional arrangement, the virtual machine manager processes the received ARP request. The virtual machine manager copies the received ARP request and provides a respective copy of the ARP request to each of the virtual machines executing in virtualized environment in the server. After receiving their copies of the ARP request, the virtual machines process them.

Thus, in the above conventional arrangement, the ARP request received by the server is processed by the virtual machine manager and by each of the virtual machines. Such processing consumes host processor, virtual machine, and virtual machine manager processing bandwidth and cycles. It also increases the heat dissipated by the host processor.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates a system embodiment.

FIG. 2 illustrates features involved in an embodiment.

FIG. 3 illustrates operations in an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

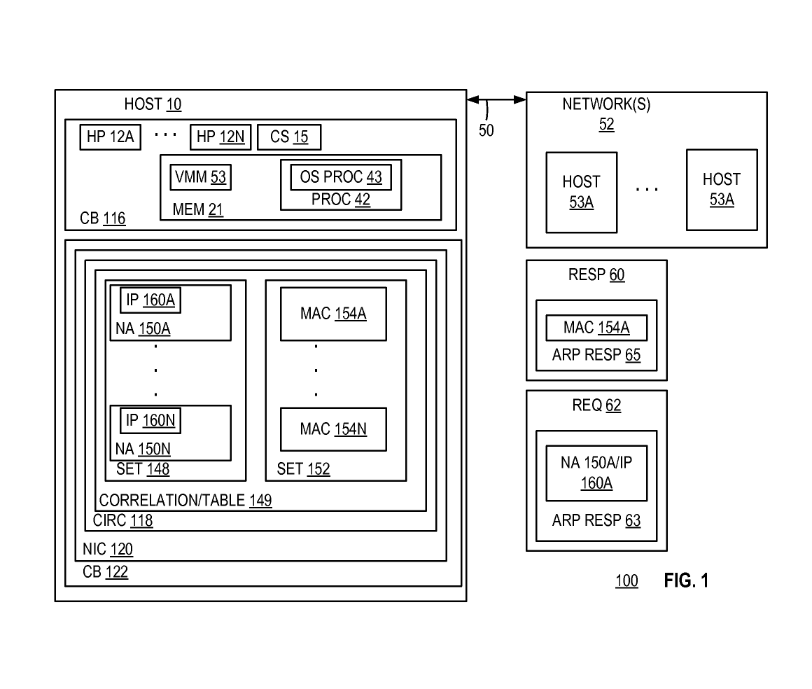

FIG. 1 illustrates a system embodiment 100. System 100 may include one or more hosts 10 and one or more networks 52 that may comprise one or more (and in this embodiment, a plurality of) hosts 53A . . . 53N that may be communicatively coupled together via one or more wireless and/or wired network links 50. In this embodiment, a host, server, appliance, client, and/or node may be used interchangeably, and may be or comprise, for example, one or more end stations, smart phones, hand held devices, personal data assistant devices, tablets, computer systems, appliances, intermediate stations, network interfaces, clients, servers, other devices, and/or portions thereof. Although components of system 100 may be referred to herein in the singular, it should be understood that each such respective component may comprise a plurality of such respective components without departing from this embodiment. In this embodiment, a “network” or “network link” may be or comprise any mechanism, instrumentality, modality, and/or portion thereof that permits, facilitates, and/or allows, at least in part, two or more entities to be communicatively coupled together. Also in this embodiment, a first entity may be “communicatively coupled” to a second entity if the first entity is capable of transmitting to and/or receiving from the second entity one or more commands and/or data. In this embodiment, a “wireless network” means a network that permits, at least in part, at least two entities to be wirelessly communicatively coupled, at least in part. In this embodiment, a “wired network” means a network that permits, at least in part, at least two entities to be communicatively coupled, at least in part, via non-wireless means, at least in part. In this embodiment, host 10, hosts 53A . . . 53N, and/or network 52 may be remote (e.g., geographically remote), at least in part, from each other.

In this embodiment, data and information may be used interchangeably, and may be or comprise one or more commands (for example one or more program instructions), and/or one or more such commands may be or comprise data and/or information. Also in this embodiment, an “instruction” may include data and/or one or more commands.

One or more hosts 10 may comprise one or more circuit boards (CB) 116 and one or more circuit boards 122. One or more circuit boards 116 may be or comprise one or more motherboards. One or more circuit boards 122 may be or comprise one or more add-in, mezzanine, daughter, and/or circuit cards that may be capable of being electrically and/or mechanically mated with one or more circuit boards 116 in such a way as to permit one or more circuit boards 122 to be and/or become communicatively coupled with one or more circuit boards 116.

Circuit board 116 may comprise one or more host processors (HP) 12A . . . 12N, memory 21, and/or one or more chipsets (CS) 15. One or more host processors 12A . . . 12N may be or comprise, for example, one or more single or multi-core host processors (HP) and/or central processing units (CPU). One or more chipsets 15 may be or comprise memory, network, and/or input/output controller circuitry and may be capable of communicatively coupling one or more HP 12A . . . 12N, memory 21, and/or circuit board 122. Circuit board 122 may comprise network interface controller (NIC) 120. NIC 120 may comprise circuitry 118.

In this embodiment, “circuitry” may comprise, for example, singly or in any combination, analog circuitry, digital circuitry, hardwired circuitry, programmable circuitry, co-processor circuitry, state machine circuitry, and/or memory that may comprise program instructions that may be executed by programmable circuitry. Also in this embodiment, a processor, HP, CPU, processor core (PC), core, and controller each may comprise respective circuitry capable of performing, at least in part, one or more arithmetic and/or logical operations, and/or of executing, at least in part, one or more instructions. Additionally, in this embodiment, a NIC and input/output (I/O) controller may comprise controller circuitry capable, at least in part, of performing, implementing, facilitating, initiating, and/or responding to one or more network and/or I/O related operations, occurrences, phenomena, and/or transactions.

Although not shown in the Figures, host 10 may comprise a graphical user interface system that may comprise, e.g., a respective keyboard, pointing device, and display system that may permit a human user to input commands to, and monitor the operation of, host 10 and/or system 100. Also in this embodiment, memory may comprise one or more of the following types of memories: semiconductor firmware memory, programmable memory, non-volatile memory, read only memory, electrically programmable memory, random access memory, flash memory, magnetic disk memory, optical disk memory, and/or other or later-developed computer-readable and/or writable memory. Also in this embodiment, a chipset may comprise circuitry capable of communicatively coupling, at least in part, other circuitry, such as, one or more processors, storage, mass storage, one or more nodes, one or more circuit boards, and/or memory.

One or more machine-readable program instructions may be stored in computer-readable/writable memory 21 and/or NIC 120. In operation of host 10 and/or system 100, these one or more instructions may be accessed and executed by circuitry 118, NIC 120, and/or one or more HP 12A . . . 12N. When so accessed and executed, this may result, at least in part, in these (and/or other) components of host 10 and/or system 100 performing the operations described herein as being performed by these (and/or other) components of host 10 and/or system 100. For example, this may result, at least in part, in one or more virtual machine monitors (VMM) 53 and/or one or more processes 42 being executed, at least in part, by one or more HP 12A . . . 12N and/or in one or more VMM 53 and/or one or more processes 42 becoming resident in memory 21. Also, for example, this also may result, at least in part, in one or more HP 12A . . . 12N executing, at least in part, virtual machines (VM) 202A . . . 202N that may be associated, at least in part, with one or more VMM 53. In this embodiment, VM 202A . . . 202N may be, comprise, result in, facilitate, instantiate, and/or embody, at least in part, virtualization, partitioning, and/or assignment of functions, operations, circuitry, and/or components of host 10 among VM 202A . . . 202N. One or more VMM 53 may establish, control, modify, monitor, and/or initiate, at least in part, such virtualization, partitioning, and/or assignment among VM 202A . . . 202N. Additionally or alternatively, without departing from this embodiment, one or more VMM 53 may establish, control, modify, monitor, and/or initiate, at least in part, VM 202A . . . 202N. In this embodiment, one or more VMM 53 may be or comprise one or more processes. Without departing from this embodiment, one or more VMM 53, one or more processes 42, one or more processes 43, one or more VM 202A, and/or one or more operating systems 204 may be mutually distinct, at least in part, from each other, or alternatively, may not be mutually distinct, at least in part, from each other. Also without departing from this embodiment, one or more VM (e.g., one or more VM 202A) may be distinct, at least in part, from one or more other VM (e.g., one or more VM 202N), or alternatively, may not be distinct, at least in part, from one or more VM 202N.

In this embodiment, a portion or subset of an entity may comprise all or less than all of the entity. Also, in this embodiment, a process, thread, daemon, program, driver, operating system, application, kernel, virtual machine, and/or virtual machine monitor each may (1) comprise, at least in part, and/or (2) result, at least in part, in and/or from, execution of one or more operations and/or program instructions.

In this embodiment, hosts 10 and/or 53A . . . 53N may be respectively identical or similar in construction and/or operation to each other. However, without departing from this embodiment, hosts 10 and/or 53A . . . 53N may differ from each other, at least in part, in terms of respective constructions and/or operations.

In operation, host 10 may be capable of exchanging (e.g., via one or more links 50) data and/or commands with hosts 53A . . . 53N and/or network 52, in accordance with one or more protocols. These one or more protocols may be compatible with, e.g., an Ethernet protocol, Transmission Control Protocol/Internet Protocol (TCP/IP), and/or Address Resolution Protocol (ARP).

The Ethernet protocol that may be utilized in system 100 may comply or be compatible with the protocol described in Institute of Electrical and Electronics Engineers, Inc. (IEEE) Std. 802.3, 2000 Edition, published on Oct. 20, 2000. The TCP/IP that may be utilized in system 100 may comply or be compatible with the protocols described in Internet Engineering Task Force (IETF) Request For Comments (RFC) 791 and 793, published September 1981. The ARP that may be utilized in system 100 may comply or be compatible with the protocol described in IETF RFC 826, published November 1982 (hereinafter referred to as “Ethernet ARP”). Of course, many different, additional, and/or other protocols may be used for such data and/or command exchange without departing from this embodiment, including for example, later-developed versions and/or updates of the aforesaid and/or other protocols.

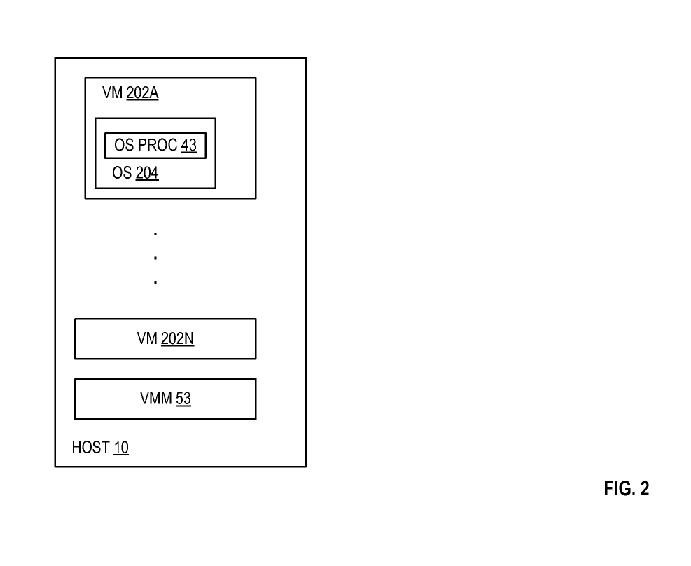

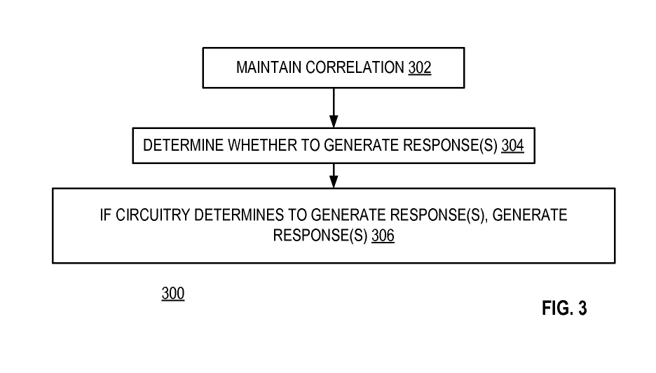

With particular reference now being made to FIGS. 1 to 3, operations 300 (see FIG. 3) that may be performed in system 100 will be described. In operation of host 10, one or more processes 42 and/or one or more processes 43 may generate, provide and/or populate (e.g., in not shown memory), at least in part, in circuitry 118 one or more correlations 149 between a set 148 of network addresses (NA) 150A . . . 150N and a set 152 of corresponding medium access control (MAC) addresses 154A . . . 154N that may be assigned to, belong to, and/or be associated with, at least in part, host 10 and/or one or more entities (e.g., not shown ports) of host 10 that may be accessible, at least in part, by one or more hosts 53A . . . 53N in one or more networks 52. Such provision and/or population may be implemented, at least in part, by one or more processes 42 and/or 43 utilizing, for example, a not shown Ethernet device driver (and/or other not shown interface) associated with NIC 120 and/or circuitry 118. These one or more not shown ports may be comprised, for example, in NIC 120 and/or circuitry 118. Circuitry 118 may maintain, at least in part, correlation 149 in circuitry 118 and/or NIC 120 in the form of, for example, one or more tables that may embody the correlation 149 (see operation 302 in FIG. 3).

In this embodiment, network addresses 150A . . . 150N may be or comprise respective IP addresses 160A . . . 160N. Also in this embodiment, MAC addresses 154A . . . 154N may be or comprise respective MAC addresses that may comply and/or be compatible with, at least in part, Ethernet protocol. In correlation 149, respective network addresses and/or respective IP addresses that may be assigned to and/or associated with, at least in part, respective entities (e.g., respective ports) of host 10 may be correlated and/or associated with corresponding MAC addresses that also may be assigned to and/or associated with those respective entities. For example, if one or more network addresses 150A, one or more IP addresses 160A, and one or more MAC addresses 154A are assigned to a given port of host 10, correlation 149 may correlate and/or associate one or more network addresses 150A and IP addresses 160A with one or more MAC addresses 154A.

In this embodiment, a port of an entity may be or comprise circuitry that is accessible, at least in part, by another entity. In this embodiment, a first entity may be considered to be accessible by a second entity if the second entity is capable, at least in part, of (directly and/or indirectly) issuing one or more packets to and/or receiving one or more packets from the first entity, or vice versa. In this embodiment, a “packet” may comprise one or more symbols and/or values. Also in this embodiment, a correlation between a first entity and a second entity may be, comprise, embody, involve, establish, and/or facilitate, at least in part, an association, interaction, and/or relationship between the first entity and the second entity. In this embodiment, an address may be, comprise, locate, identify, indicate, and/or specify one or more logical, physical, and/or virtual entities.

In operation of system 100, one or more hosts (e.g., one or more hosts 53A) may generate and transmit to host 10, via one or more networks 52 and one or more links 50, one or more packets that be, comprise, and/or embody, at least in part, one or more requests 62. One or more requests 62 may be, comprise, and/or embody, at least in part, one or more Ethernet ARP requests 63 (e.g., in compliance and/or compatible with, at least in part, Ethernet ARP). One or more requests 62 and/or 63 may comprise and/or be associated with, at least in part, one or more network addresses (e.g., one or more network addresses 150A) that may be or comprise, at least in part, one or more IP addresses (e.g., one or more IP addresses 160A). One or more requests 62 and/or 63 may request that one or more receivers of one or more requests 62 and/or 63 provide to the requester (i.e., host 53A) one or more MAC addresses that correspond to the one or more network addresses 150A and/or IP addresses 160A associated with the one or more requests 62 and/or 63.

Circuitry 118 and/or NIC 120 may receive, at least in part, one or more requests 62 and/or 63. In response, at least in part, to one or more requests 62 and/or 63, circuitry 118 may determine, based at least in part upon the set 148 of network addresses 150A . . . 150N in correlation 149, whether to generate one or more responses (e.g., one or more responses 60 and/or 65) to one or requests 62 and/or 63 (see operation 304 in FIG. 3). For example, circuitry 118 may determine whether to generate the one or more responses 60 and/or 65 based at least in part upon whether the one or more network addresses 150A and/or IP addresses 160A associated with the one or more requests 62 and/or 63 are comprised in set 148. Circuitry 118 may examine, at least in part, correlation 149 to determine whether the one or more network addresses 150A and/or IP addresses 160A associated, at least in part, with the one or more requests 62 and/or 63 are comprised in the correlation 149. If these one or more network addresses 150A and/or IP addresses 160A are not comprised in correlation 149, circuitry 118 may determine that no entity in host 10 has been assigned these one or more network addresses 150A and/or IP addresses 160A. In such case, in accordance with Ethernet ARP, circuitry 118 may not provide to host 53A any response to one or more requests 62 and/or 63, and circuitry 118 may take no further substantive action in connection with one or more requests 62 and/or 63.

Conversely, if these one or more network addresses 150A and/or IP addresses 160A are comprised in correlation 149 (e.g., in set 148), circuitry 118 may determine to generate one or more responses 60 and/or 65 to one or more requests 62 and/or 63. Circuitry 118 may generate one or more responses 60 and/or 65 based at least in part upon the correlation 149 and/or the one or more network addresses 150A and/or IP addresses 160A associated with the one or more requests 62 and/or 63 (see operation 306). For example, if circuitry 118 determines that one or more responses 60 and/or 65 are to be generated, circuitry 118 may select from set 152 in correlation 149 one or more MAC addresses (e.g., one or more MAC addresses 154A) that may correspond, at least in part, to the one or more network addresses 150A and/or IP addresses 160A that may be associated with one or more requests 62 and/or 63. Circuitry 118 may generate and issue to one or more hosts 53A, via one or more links 50 and one or more networks 52) one or more responses 60 that may comprise one or more Ethernet ARP responses 65. One or more ARP responses 65 may be associated with and/or comprise, at least in part, these one or more corresponding MAC addresses 154A. Additionally, in this embodiment, one or more ARP responses 65 may comply and/or be compatible with Ethernet ARP.

The techniques of this embodiment may be implemented in connection with protocols other than and/or in addition to those stated previously. For example, without departing from this embodiment, such techniques may be applied to address resolution that complies and/or is compatible with “Neighbor Discovery For IP Version 6 (IPv6)” described in IETF RFC 4861, published 2007, and/or later-developed versions and/or updates of this protocol.

Thus, an embodiment may include circuitry in a controller that may be included in a host that has at least one processor. The circuitry may maintain a correlation between a set of network addresses and a set of medium access control (MAC) addresses. The correlation may be generated, at least in part, by at least one process to be executed, at least in part, by the at least one processor. The circuitry may determine, based at least in part upon the set of network addresses, whether to generate at least one response to at least one request. If the circuitry determines to generate the at least one response, the circuitry may generate the at least one response based at least in part upon the correlation and at least one network address associated with the at least one request.

Advantageously, in this embodiment, ARP request and/or ARP response processing may be entirely or substantially entirely offloaded to circuitry 118 from the VMM, host operating system, and/or host processor in host 10. Further advantageously, in this embodiment, this may permit such processing to be handled entirely by circuitry 118 independently of the VMM, host operating system, and/or host processor. Also advantageously, in this embodiment, circuitry 118 may be capable of concurrently processing many hundreds to thousands (or more) of ARP requests and/or responses associated with hundreds of VM in host 10, without imposing any burden on the VMM, operating system, and/or host processor in connection with such processing. Advantageously, this may greatly reduce the amount of processing host processor and/or VMM processing bandwidth and cycles consumed in this embodiment. Further advantageously, this also may decrease the heat dissipated by the host processor in this embodiment.

Many other and/or additional variations, alternatives, and modifications will be apparent to those skilled in the art. For example, the techniques of this embodiment may be applied to non-virtualized environments (e.g., in which no VMM and/or virtual machines are present in host 10). Also, for example, each VM 202A . . . 202N in host 10 may be assigned one or more respective network (e.g., IP) addresses that may correspond to one or more MAC addresses in accordance with one or more correspondence relationships (e.g., in one or more many-to-one and/or or other types of correspondence relationships) that may be reflected in the one or more correlations 149. The one or more VMM 53 may generate and/or establish, at least in part, these correspondence relationships and/or one or more correlations 149. Accordingly, the accompanying claims are intended to encompass these and all such variations, alternatives, and modifications.

What is claimed is:

1. An apparatus comprising:
circuitry comprised in a controller that is to be comprised in a host that comprises at least one processor, the circuitry to maintain a correlation between a set of network addresses and a set of medium access control (MAC) addresses, the correlation to be generated, at least in part, by at least one process to be executed, at least in part, by the at least one processor, the circuitry to determine, based at least in part upon the set of network addresses, whether to generate at least one response to at least one request, and if the circuitry determines to generate the at least one response, the circuitry to generate the at least one response based at least in part upon the correlation and at least one network address associated with the at least one request.

2. The apparatus of claim 1, wherein:
the circuitry is to determine whether to generate the at least one response based at least in part upon whether the at least one network address is comprised in the set of network addresses;
the set of network addresses comprises a plurality of internet protocol (IP) addresses); and
the set of MAC addresses comprises a plurality of MAC addresses.

3. The apparatus of claim 1, wherein:
the at least one request comprises an Ethernet address resolution protocol (ARP) request; and
the at least one response comprises an Ethernet ARP response.

4. The apparatus of claim 1, wherein:
the at least one process comprises at least one host operating system process; and
the at least one processor is to execute, at least in part, at least one virtual machine monitor associated with virtual machines, at least one of the virtual machines comprising an operating system that comprises the at least one host operating system process.

5. The apparatus of claim 1, wherein:
a first circuit board comprises, at least in part, the controller;
the controller is a network interface controller;
the host comprises a second circuit board that comprises, at least in part, the at least one processor; and
the first circuit board is to be coupled to the second circuit board.

6. The apparatus of claim 1, wherein:
if the at least one network address is comprised in the set of network addresses, the circuitry determines that the at least one response is to be generated;
if the circuitry determines to generate the at least one response, the circuitry is to select from the set of MAC addresses at least one MAC address that corresponds, at least in part, to the at least one network address;
the at least one response comprises the at least one MAC address; and
the at least one request comprises the at least one network address.

7. A method comprising:
maintaining, by circuitry, a correlation between a set of network addresses and a set of medium access control (MAC) addresses, the circuitry being comprised in a controller that is to be comprised in a host that comprises at least one processor, the correlation to be generated, at least in part, by at least one process to be executed, at least in part, by the at least one processor;
determining, by the circuitry, based at least in part upon the set of network addresses, whether to generate at least one response to at least one request; and
if the circuitry determines to generate the at least one response, generating by the circuitry the at least one response based at least in part upon the correlation and at least one network address associated with the at least one request.

8. The method of claim 7, wherein:
the circuitry is to determine whether to generate the at least one response based at least in part upon whether the at least one network address is comprised in the set of network addresses;
the set of network addresses comprises a plurality of internet protocol (IP) addresses); and
the set of MAC addresses comprises a plurality of MAC addresses.

9. The method of claim 7, wherein:
the at least one request comprises an Ethernet address resolution protocol (ARP) request; and
the at least one response comprises an Ethernet ARP response.

10. The method of claim 7, wherein:
the at least one process comprises at least one host operating system process; and
the at least one processor is to execute, at least in part, at least one virtual machine monitor associated with virtual machines, at least one of the virtual machines comprising an operating system that comprises the at least one host operating system process.

11. The method of claim 7, wherein:
a first circuit board comprises, at least in part, the controller;
the controller is a network interface controller;
the host comprises a second circuit board that comprises, at least in part, the at least one processor; and
the first circuit board is to be coupled to the second circuit board.

12. The method of claim 7, wherein:
if the at least one network address is comprised in the set of network addresses, the circuitry determines that the at least one response is to be generated;
if the circuitry determines to generate the at least one response, the circuitry is to select from the set of MAC addresses at least one MAC address that corresponds, at least in part, to the at least one network address;
the at least one response comprises the at least one MAC address; and
the at least one request comprises the at least one network address.

13. Computer-readable memory storing one or more instructions that when executed by a machine result in performance of operations comprising:
maintaining, by circuitry, a correlation between a set of network addresses and a set of medium access control (MAC) addresses, the circuitry being comprised in a controller that is to be comprised in a host that comprises at least one processor, the correlation to be generated, at least in part, by at least one process to be executed, at least in part, by the at least one processor;
determining, by the circuitry, based at least in part upon the set of network addresses, whether to generate at least one response to at least one request; and
if the circuitry determines to generate the at least one response, generating by the circuitry the at least one response based at least in part upon the correlation and at least one network address associated with the at least one request.

14. The computer-readable memory of claim 13, wherein:
the circuitry is to determine whether to generate the at least one response based at least in part upon whether the at least one network address is comprised in the set of network addresses;
the set of network addresses comprises a plurality of internet protocol (IP) addresses); and
the set of MAC addresses comprises a plurality of MAC addresses.

15. The computer-readable memory of claim 13, wherein:
the at least one request comprises an Ethernet address resolution protocol (ARP) request; and
the at least one response comprises an Ethernet ARP response.

16. The computer-readable memory of claim 13, wherein:
the at least one process comprises at least one host operating system process; and
the at least one processor is to execute, at least in part, at least one virtual machine monitor associated with virtual machines, at least one of the virtual machines comprising an operating system that comprises the at least one host operating system process.

17. The computer-readable memory of claim 13, wherein:
a first circuit board comprises, at least in part, the controller;
the controller is a network interface controller;
the host comprises a second circuit board that comprises, at least in part, the at least one processor; and
the first circuit board is to be coupled to the second circuit board.

18. The computer-readable memory of claim 13, wherein:
if the at least one network address is comprised in the set of network addresses, the circuitry determines that the at least one response is to be generated;
if the circuitry determines to generate the at least one response, the circuitry is to select from the set of MAC addresses at least one MAC address that corresponds, at least in part, to the at least one network address;
the at least one response comprises the at least one MAC address; and
the at least one request comprises the at least one network address.

19. The apparatus of claim 1, wherein:
the at least one processor is to execute, at least in part, at least one virtual machine monitor associated with virtual machines, the virtual machines being assigned network addresses and one or more corresponding MAC addresses in accordance with at least one correspondence relationship established, at least in part, by the at least one virtual machine monitor.
